(19) United States
(12) Patent Application Publication
(10) Pub. No.: US 2009/0284481 A1
(43) Pub. Date: Nov. 19, 2009

(54) Devices and Methods for a Backlight to Illuminate Both a Main Display and Morphable Keys or Indicators

(75) Inventors: Li Zhuang, Long Grove, IL (US); John Kaehler, Mundelein, IL (US); Sen Yang, Palatine, IL (US)

Correspondence Address: Motorola, Inc., 600 North US Highway 45, Libertyville, IL, 60048, US

(73) Assignee: MOTOROLA, INC., Libertyville, IL (US)

(21) Appl. No.: 12/122,666

(22) Filed: May 17, 2008

(51) Int. Cl. G06F 3/041; G09G 3/36

(52) U.S. Cl. 345/173; 345/102

(57) ABSTRACT

Disclosed are devices and methods for a display of an electronic device, the display including a backlight and a conductive layer, wherein the backlight illuminates both a main display and morphable keys or indicators. The conductive layer includes two separate portions. One portion of the conductive layer is part of a main display. The second portion, the non-main display region of the conductive layer includes at least one shutter configured to allow light from the backlight to pass therethrough and configured to block light from the backlight from passing therethrough. Accordingly, the shutter in part forms a morphable or smart key, or indicator that is illuminated by the backlight that illuminates the main display. In this way, separate LEDs to illuminate a morphable or smart key or indicator are not utilized.

### FIELD

Disclosed are devices and methods for a display of an electronic device, the display including a backlight and a conductive layer including at least one shutter, wherein the backlight illuminates both a main display and at least one morphable key or indicator.

### BACKGROUND

Mobile communication devices are a part of everyday life. Manufacturers constantly strive to include advanced features in their mobile communication devices as well as maintain a design edge. For example, cellular telephones include features such as still and video cameras, video streaming and two-way video calling, email functionality, Internet browsers, music players, FM radios with stereo audio and organizers. Cellular telephones in particular are becoming more than simply mobile communication devices. They are evolving into powerful tools for information management. Additionally, manufacturers of mobile communication devices constantly strive to reduce costs of production while improving their products.

A desirable design feature of an electronic device, and in particular, a mobile communication device is a morphable, smart or stealth button, key or indicator. As mentioned above, mobile communication devices may include many different features. A morphable key, button or indicator accordingly may be illuminated when a particular function, mode or application is active.

There are many different mobile communication device form factors. For example, popular are the candy bar, clam shell, and slider form factors. In the clam shell form factor, for example, there may a caller ID display on the top housing, and a full display on the bottom housing. Caller ID displays are becoming more functional with their increased size and quality. A design option along side a Caller ID display is to include morphable buttons, keys or display indicators to avoid a cluttered appearance since they may be illuminated only when certain functions, modes or applications are active. Morphable keys are illuminated by their own individual LEDs. However, morphable buttons, keys or display indicators that are illuminated by their own individual LEDs have several drawbacks. For example, the structure to support individual LEDs is complicated and increases a flip's thickness. There may be complex electrical and mechanical issues. Moreover, the power consumption to illuminate individual LEDs is high. Depending on the number of morphable buttons, keys or display indicators, inclusion of such keys in an electronic device may be costly.

### BRIEF DESCRIPTION OF THE DRAWINGS

FIG. 1 illustrates an electronic device, and in particular, a mobile communication device having a display including a backlight and a conductive layer including at least on shutter, wherein the backlight illuminates both a main display and at least one morphable key or indicator utilizing a shutter of the conductive layer;

FIG. 2 illustrates an LCD backlight assembly including a light pipe that receives light from one or more backlight LEDs;

FIG. 3 is a block diagram of a display of an electronic device illustrating at least one shutter to allow light to pass and block light from passing from the backlight assembly, the shutter is included in or formed in a conductive layer of the display elements stack;

FIG. 4 depicts two views of an apportionment of a conductive layer relative to other display stack elements;

FIG. 5 another perspective view of the back light and the conductive layer, and illustrates extended regions of either the conductive layer and/or the backlight;

FIG. 6 depicts selected components of an electronic device, and in particular a mobile communication device including a display assembly including a conductive layer having a non-display region;

FIG. 7 depicts lines independent from the active matrix that drive shutters remotely;

FIG. 8 depicts that the shutters can be driven directly from an extension of the active matrix of the main display (either rows or columns) or additional rows or columns; and

FIG. 9 is a flowchart of a method of the described electronic device including one or a plurality of shutters and one or a plurality of icons of the morphable buttons or indicators.

### DETAILED DESCRIPTION

Disclosed are devices and methods for a display of an electronic device, the display including a backlight and a conductive layer including at least one shutter, wherein the backlight illuminates both a main display and at least one morphable key or indicator. The conductive layer includes two separate portions. One portion of the conductive layer is part of a main display. The second portion of the conductive layer herein after referred to as a non-display region and includes at least one shutter configured to allow light from the backlight to pass therethrough and configured to block light from the backlight from passing therethrough. Accordingly, the shutter in part forms a morphable or smart key that is illuminated by the backlight that also illuminates the main display. In this way, separate LEDs to illuminate the morphable or smart key are not utilized.

The simplified structure of an extended backlight that is configured to illuminate both a main display and the disclosed morphable or smart keys may beneficially provide cost savings since the circuitry may be less complex that morphable keys that are illuminated by their own individual LEDs. Moreover, in utilizing the backlight to illuminate the morphable keys or indicators, brightness may be enhanced over that of such keys illuminated by individual LEDs. Furthermore, in the disclosed methods and devices utilizing the backlight to illuminate the morphable keys or indicators, manufacturers may have more flexibility in their location, the number of icons per shutter, their color, and the icon designs.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

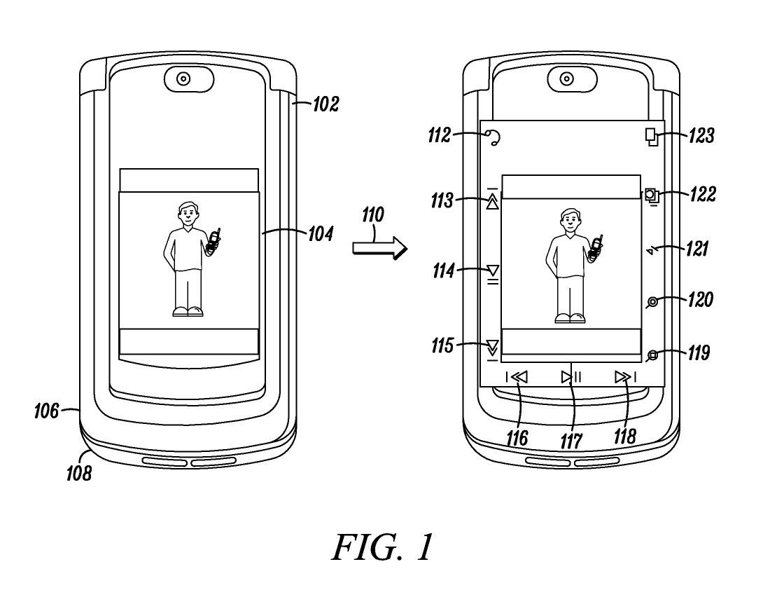

FIG. 1 illustrates an electronic device, and in particular, a mobile communication device 102 having a display 104 including a backlight and a conductive layer including at least one shutter, wherein the backlight illuminates both a main display and at least one morphable key or indicator. The depicted mobile communication device 102 has a clam shell form factor that includes a flip housing 106 and a main housing 108. The described mobile communication device 102 including a backlit display may be of any form factor configuration. Moreover, any type of electronic device that includes a backlit display is within the scope of this discussion. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

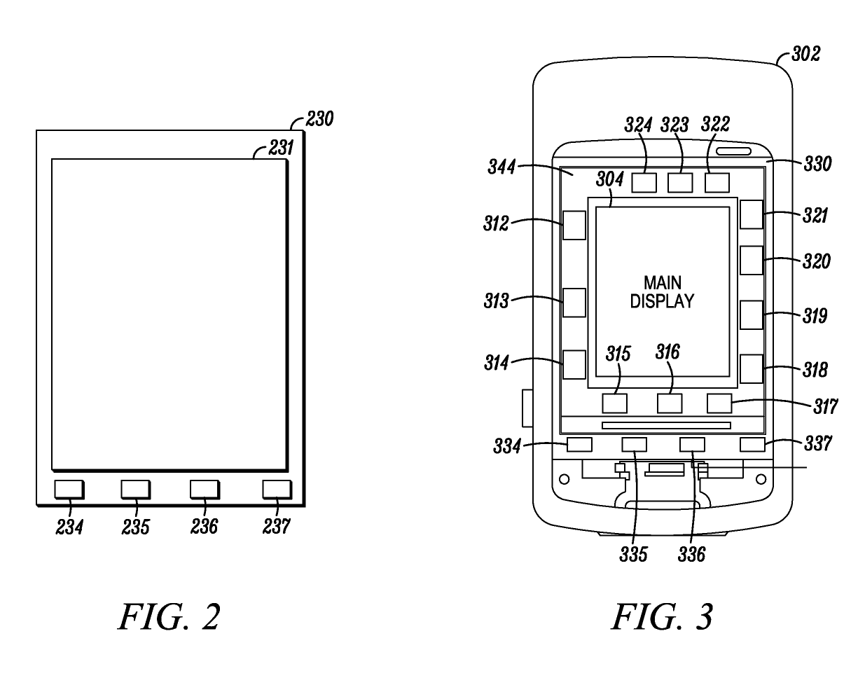

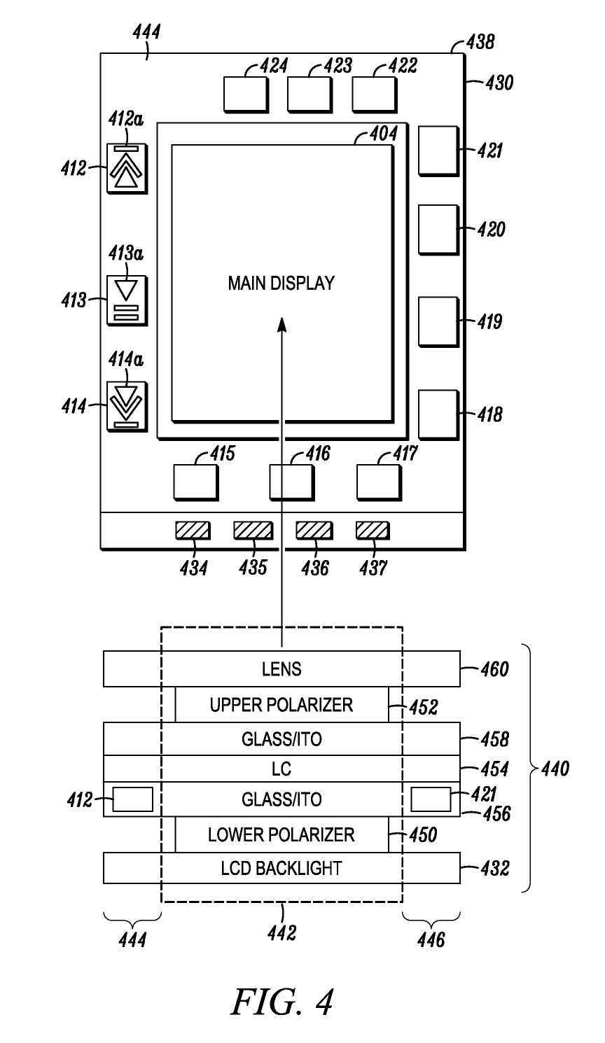

The mobile communication device 102 is first depicted in stealth mode. That is, the morphable buttons that are along side the display 104 are not visible. The arrow 110 indicates that the device 102 has changed modes or that an application has been initiated. Morphable buttons 112, 113, 114, 115, 116, 117, 118, 119, 120, 121, 122 and 123 are accordingly visible. The backlight (see FIGS. 2 and 3) extends beyond the main display, as does a conductive layer. The conductive layer (see FIG. 4) includes at least two regions, a display 104 region, and a separate region, and in the depicted embodiment, in a perimeter region of the conductive layer, where at least one morphable button or indicator 112 is formed.

While the discussion below mostly refers to an LCD type display, it is understood that any type of display is within the scope of this discussion. For example, a display may be an emissive display such as OLED or a CRT display. The light source of such an emissive display may be shared by the morphable buttons as described below.

FIG. 2 illustrates an LCD backlight assembly 230. The light pipe 231 receives light from one or more backlight LEDs 234, 235, 236, and 237. The backlight has a particular area that may be dictated by the size constraints of the housing in which it is supported or other considerations. The backlight assembly 230 can illuminate both the display 104 (see FIG. 1) and at least one morphable button or indicator 112, 113, 114, 115, 116, 117, 118, 119, 120, 121, 122, and 123. The backlight 230 may extend up to the width and/or the length of the flip housing 106, of this example.

FIG. 3 is a block diagram of a display of an electronic device 302 illustrating at least one shutter to allow light to pass and block light from passing from the backlight assembly 230 (see FIG. 2), the shutter included in or formed in a conductive layer of the display elements stack (see FIG. 4). Depicted is the outer border 330 of the backlight assembly 230 (see FIG. 2) that can be illuminated by one or more backlight LEDs 334, 335, 336, and 337. Also depicted are a main display 304 and at least one shutter 312 along side the main display 304 that is in the separate region 344. In the depicted embodiment, a plurality of shutters 312, 313, 314, 315, 316, 317, 318, 319, 320, 321, 322, 323, and 324 may be positioned any suitable location along side or proximal the main display in the non-main display region 344 of the conductive layer. In the depicted embodiment, the non-main display region 344 is the perimeter region of the display assembly. In another embodiment, the non-main display region 3444 may be positioned on one, two or three sides of the main display instead of occupying a perimeter region of the display assembly as depicted. It is understood that there may be any arrangement of the non-main display region and therefore of one or more shutters with respect to the main display is within the scope of this discussion.

As mentioned above, the backlight assembly 230 (see FIG. 2) can be illuminated by one or more backlight LEDs 334, 335, 336, and 337. The backlight assembly 230 provides illumination to both the main display 304 and to one or more shutters 312, 313, 314, 315, 316, 317, 318, 319, 320, 321, 322, 323, and 324 of the non-main display region 344. It is understood that the backlight LEDs 334, 335, 336, and 337 may be any suitable number and/or in any suitable arrangement to illuminate both the main display 304 and one or more shutters 312-324.

FIG. 4 depicts two views of the disclosed display assembly 438, and in particular an apportionment of a conductive layer relative to other display stack elements. The top view of FIG. 4 is similar to that shown of FIG. 3. The bottom view is a cross-sectional view 440 of certain of the stack elements. As in FIG. 3, the top view of FIG. 4 illustrates one or more backlight LEDs 434, 435, 436, and 437 of the LCD backlight 432 which is part of the backlight assembly 230 (see FIG. 2) is utilized to illuminate a main display 404 and at least one shutter 412 proximal the main display 404. In the top portion of FIG. 4, a plurality of shutters 412-424 is depicted. A shutter can be, for example, LCD, PDLC, Electrowetting, Cholesteric display etc. Also depicted are icons 412a, 413a and 414a associated with shutters 412, 413 and 414 respectively. As will be discussed below, different portions of an icon may be illuminated independently of another portion of the icon. In this way, two distinct icons may be formed and associated with one or more shutters. Where two or more than one shutters are closely arranged, the arrangement may be referred to as a segment. More than one shutter may occupy any segment. More than one icon, for example, icon 412a having several distinct parts, may be associated with a single shutter or a segment. As will be discussed below, different color filters may be associated with different parts of one or more icons.

As mentioned, the bottom view depicts elements of the stack 440, which of course may be of any suitable configuration or order. The stack elements depicted in FIG. 4 are for illustrative purposes. The stack 440 includes a main display 404 region 442. The stack 440 further includes non-main display regions 444a and 444b, that together form non-main display region 444. The non-main display region 444 includes at least one shutter 412 allow light to pass through from the backlight 430. The non-main display region 444 of the top portion of FIG. 4 particularly corresponds to non-main display regions 444a and 444b of either conductive layer 454 or 456 in the bottom portion of FIG. 4.

The stack 440 is depicted as including the LCD backlight 430. The backlight 430 spans the main display 404 region 442 as well as the non-main display regions 444a and 444b. Certain of the stack 440 elements are depicted as only included in main display 404 region 442. For example, the lower polarizer 450 and the upper polarizer 452 are stack 440 elements that may be utilized by the main display 404, and in one embodiment are not included in non-main display region 444. The lack of polarizers in the non-main display region 444 may enhance brightness of illuminated icons of the morphable buttons or indicators 112-123. The stack 440 may further include a lens element 460 that spans the main display 404 region 442 as well as one or more morphable buttons 112-123 (see FIG. 1) of the non-main display region 444.

The stack 440 may further include a liquid crystal (LC) element 452 that spans the main display 404 region 442 as well as the non-main display region 444. The stack 440 is depicted as including at least one conductive layer 456 and a second conductive layer 458. At least one conductive layer 456 and/or 458 may have an area that is substantially the same size as the area of the backlight. At least one conductive layer 456 and/or 458 is in alignment with the backlight 432. The conductive layer 456 is depicted as having two portions, one that is part of the main display 404 region 442, and one that is outside the main display 404 region 442. The area outside the main display area 442 is depicted as non-main display region 444.

In the lower portion of FIG. 4, the cross-sectional view of the non-main display region 444 of a conductive layer 456 further depicts associated shutters 412 and 421. As discussed above, the shutter may either allow light to pass therethrough or block light from passing therethrough. The conductive layer 456 can be any type of conductive layer. In the depicted embodiment the conductive layer 456 is glass/ITO. In the depicted embodiment there is another conductive layer 458 which may instead include shutters 412 and/or 421. Alternatively, one or more icons (see morphable buttons 112-123 in FIG. 1) may be etched or otherwise formed in the second conductive layer 458 or another layer suitable stack 440 element. One or more color filters may be positioned so that an icon, when illuminated, may have a particular color. Alternatively, no color filters may be positioned so that an icon will transmit the light color of the backlight 432.

The shutter 412 may be for example an aligned optical shutter. The optical shutter cell can be implemented using any display technology that can be selectively addressed to change regions from a clear state to an absorbing state. Although the a common embodiment uses PDLC, Cholesteric Display, TN, Electrowetting Display, etc. or any other kind of optical shutter technology for the optical shutter, an optical shutter layer can be made using neumatic liquid crystal technology (such as twisted neumatic or super twisted neumatic liquid crystals), ferro-electric liquid crystal technology, electrically-controlled birefringent technology, optically-compensated bend mode technology, guest-host technology, and other types of light modulating techniques.

The optical shutter may operate in any suitable manner. For example, each optical shutter pixel can act like an independent shutter for the image underneath the pixel. Thus, different images or combinations of images are shown on the display depending on which optical shutter pixels are open-shuttered and which optical shutter pixels are closed-shuttered. Depending upon the implementation of the shutter 412 and 421, the shutter may be activated by an active matrix or activated remotely, which will be discussed in more detail below.

An optical shutter cell may include optical shutter material sandwiched between two transparent substrates bearing electrodes. Preferably, the upper electrode is a solid ITO layer acting as a ground, and the lower electrode is a patterned ITO layer for providing optical shutter pixels to reveal images. The pattern could be implemented in the upper electrode with the solid ground plane on the lower electrode or both electrodes could be patterned; however, the pattern on the upper electrode might be seen by the user under bright light conditions even when the display is off.

The display with aligned optical shutter and backlight cells may be thin and flexible enough to be integrated with a touchscreen. Thus, a display with aligned optical shutter and backlight cells applicable for use with a touchscreen provides a high-contrast, low-cost, low-current-drain alternative to traditional displays. This display is particularly suited for application over a touchscreen to create a keyless input device. U.S. Pat. No. 6,842,170 is hereby incorporated by reference in its entirety, and any continuations thereof. While the reference describes a touchscreen in relation to a keypad, certain or all of the disclosure therein may be applicable to the present disclosure.

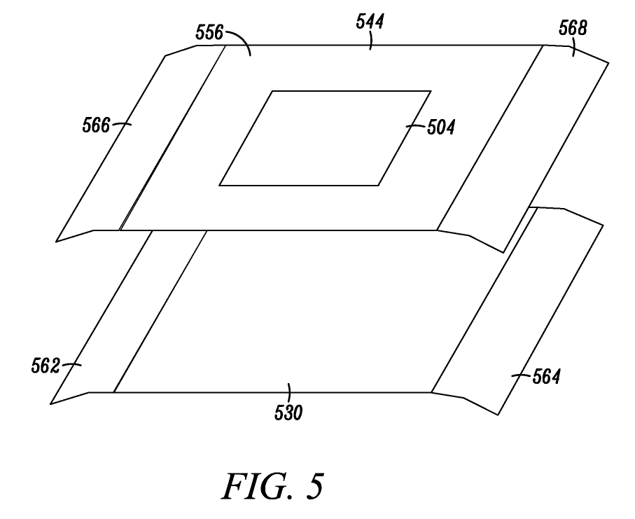

FIG. 5 illustrates another perspective view of a backlight 530 and a conductive layer 556 (or alternatively 558) and further illustrates extended regions of either the conductive layer and/or the backlight. The backlight 530 having a backlight area is in alignment with the conductive layer 556. The conductive layer 556 has an area larger than the area of the main display region of the conductive layer 556. A non-main display region 544 of the conductive layer 556 that is proximal the main display region supports at least one shutter. The backlight 530 can illuminate both the main display region defined by the main display 504 and the non-main display region 544.

As mentioned, FIG. 5 illustrates extended regions of either the conductive layer 556 and/or the backlight 530. One or more extended regions 566 and/or 568 of the conductive layer 530 may be curved or have another organic shape, for example, that takes the contour of a housing that supports it. Shutters as described above may be supported by the extended regions of the conductive layer 556 as described above so that the so that light emanates from the sides of the housing when a shutter or other lighting assembly allows light from the backlight 530 to pass therethrough. Alternatively, the backlight also may have extended regions 562 and 564 as well so that the brightness of the light transmitted through the shutters of the shutters or other lighting assembly of the extended regions 566 and/or 568 is as bright as those of the non-main display region 544. The extended regions 566 and/or 568 of the conductive layer 556 and/or the extended regions 562 and/or 564 of the backlight 530 may be part of the whole or may be separate or independent. The extended regions 556 and/or 568 of the conductive layer 556 may be plastic or some other substrate material. That the extended regions 556 and/or 568 may be illuminated by the backlight 530 instead of by separate LEDs provides many of the benefits describe above.

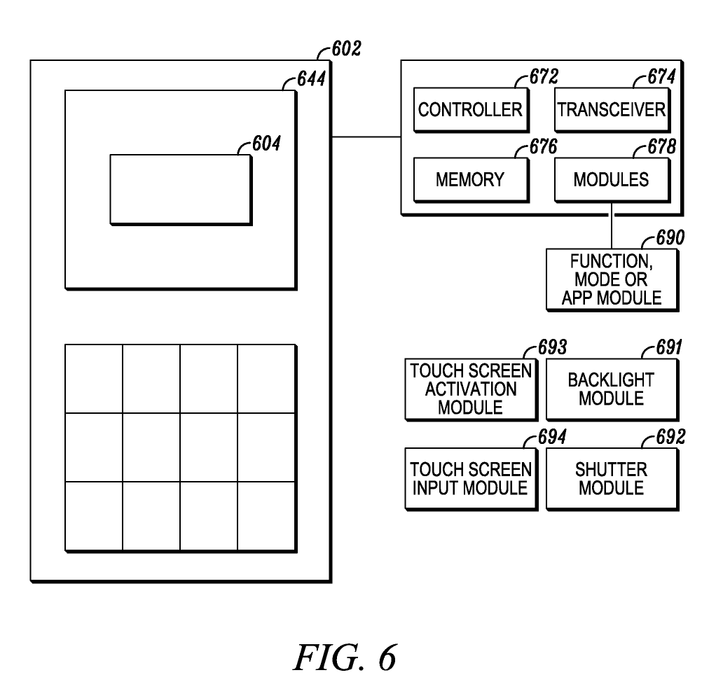

FIG. 6 depicts selected components of an electronic device, and in particular a mobile communication device including a display 604 assembly including a conductive layer, for example conductive layer 456 (see FIG. 4) having a non-main display region 644. As mentioned above, the electronic device 602 may be any type of device including a main display 604. A mobile communication device may include, for example, a controller 672, a transceiver 674, a memory 676 and modules 678. The modules may include for example a mode or application module 680, a backlight module 682, and a shutter activation module 684.

The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

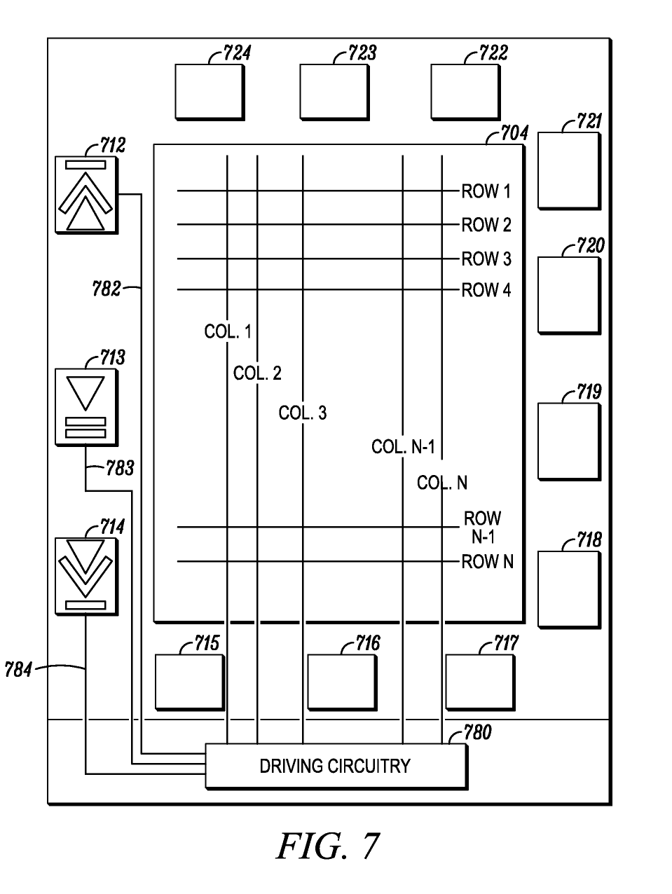

Depending upon the implementation of the shutter, the shutter may be activated by activated remotely or by an active matrix. FIG. 7 depicts lines 781, 782 and 783 that are independent from the active matrix, the independent lines drive shutters 712, 713 and 714 respectively. Lines 782, 783 and 784 are coupled the driving circuitry 780 and are driven separately from the active matrix so that the shutters are remotely activated. While FIG. 7 depicts driving circuitry 780 driving both the active matrix of display 704 and shutters 712, 713 and 714, more than one driving circuitry is within the scope of this discussion. The active matrix of the main display 704 includes matrix lines, for example, Row 1, Row 2, Row 3, Row 4, Row n−1 and Row n. Driving circuitry 780 is coupled to column lines, Col. 1, Col. 2, Col. 3, Col. n−1 and Col. n, and as mentioned may drive both the active matrix and the remotely activated shutters, as depicted shutters 712, 713 and 714 by lines 782, 783 and 784. The driving circuitry may be in communication with controller 672 (see FIG. 6) that is further in communication with modules 678 including instructions. As mentioned, a touch screen may be associated with a shutter that is configured to be responsive to touch when the shutter allows light from the backlight to pass therethrough. The activation of the shutter can be performed by the display driving circuitry 780 and/or software triggered by actions from touch sensor or any other actions of the whole device.

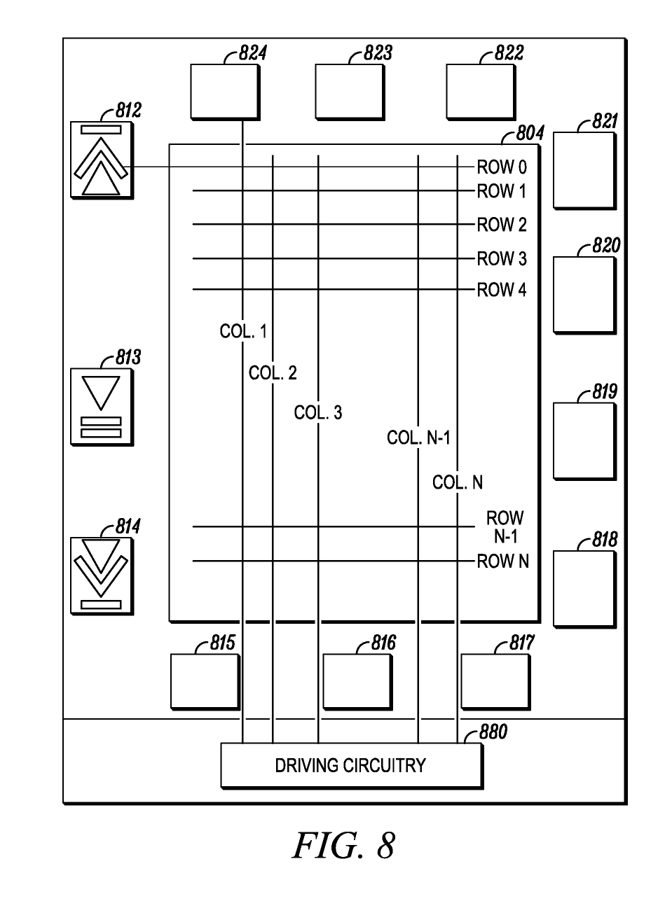

FIG. 8 depicts that the shutters can be driven directly from an extension of the active matrix of the main display 804 (either rows or columns) or additional rows or columns such as row 0. The active matrix of the main display 704 includes matrix lines, for example, Row 0, Row 1, Row 2, Row 3, Row 4, Row n−1 and Row n. In the depicted embodiment, Row 0 may drive shutter 712. Also Col. 1 may drive shutter 824. Accordingly, the activation of the shutter can be performed by the display driving circuitry 880 and/or software triggered by actions from touch sensor or any other actions of the whole device.

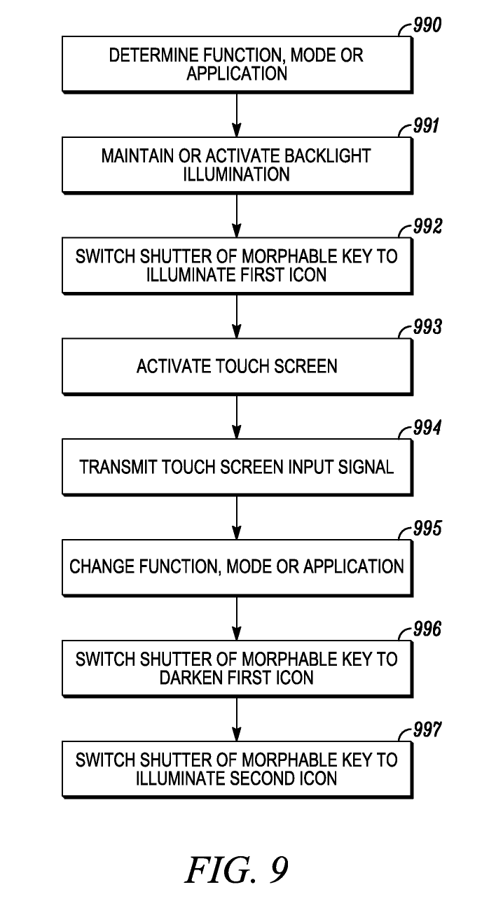

FIG. 9 is a flowchart of a method of the described electronic device. As mentioned above, there may be one or a plurality of shutters 412-424 (see FIG. 4) and therefore one or a plurality of icons of the morphable buttons or indicators 112-123 (see FIG. 1). A single morphable button, for example, button 112 may be associated with two or more icons. A different icon in the position of icon 112 may be illuminated depending upon, for example, the mode of the device. For example, a mobile communication device may be in music playback mode and show a first set of icons such as icons 112-123. At another time, the mobile communication device may be in call answering mode and show a second set of icons that may include icons in the positions of icons such as icons 112-123. It is understood that an electronic device, and in particular a mobile communication may have at least one mode including a camera mode having functions still, video, zoom in, zoom out, flash, capture, trash, or back, or a media playback mode having functions rewind, play, fastforward, or a video conference mode, or an internet link mode. A plurality of icons, relating for example to different modes, and corresponding to a single shutter 412 may be arranged so that a user perceives they share a position on the display. Moreover, different color filters may be applied to different icons corresponding to a single shutter.

The method of the electronic device may include determining the mode or application of the device 990 in accordance with mode or application module 690 (see FIG. 6). The method may include maintaining or activating backlight illumination 991 in accordance with backlight module 691. The method may include switching 992 the shutter of a morphable key to allow illumination of a first icon that is associated with the mode or application determining step 990. The shutter may allow illumination in accordance with the shutter module 692. Once illuminated, the touchscreen associated with the shutter may be activated 993 in accordance with the touchscreen module 693. The touch screen associated with the shutter may be configured to be responsive to touch when the shutter allows light from the backlight to pass therethrough. The touchscreen may receive 994 touchscreen input in accordance with touch screen input module 694 to transmit a touch signal to the controller 672 to initiate or activate a function of the mode or application. The method may also include changing the application or mode 995 in accordance with the mode or application module 690 In turn, the method may include that the shutter not allow light to pass therethrough so as to darken the first icon 996 and then to allow light to pass in a manner that will illuminate a second icon 997 in accordance with the shutter module 692.

The disclosed devices and methods for a display of an electronic device include a backlight and a conductive layer where the backlight can illuminate both a main display and morphable keys, the shutters of which are formed on or in or embedded in a conductive layer. The conductive layer includes two separate portions. One portion of the conductive layer is part of a main display. A second portion, or non-main display region, of the conductive layer includes at least one shutter configured to allow light from the backlight to pass therethrough and configured to block light from the backlight from passing therethrough. Accordingly, the shutter that in part forms a morphable or smart key that is illuminated by the backlight that illuminates the main display. In this way, separate LEDs to illuminate a morphable or smart key are not utilized.

The simplified structure of an extended backlight that is configured to illuminate both a main display and the disclosed morphable or smart keys may beneficially provide cost savings since the circuitry may be less complex that morphable keys that are illuminated by their own individual LEDs. Moreover, in utilizing the backlight to illuminate the morphable keys or indicators, brightness may be enhanced over that of such keys illuminated by individual LEDs. Furthermore, in the disclosed methods and devices utilizing the backlight to illuminate the morphable keys or indicators, manufacturers may have more flexibility in their location, their color, and the icon designs.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A display of an electronic device, comprising:
a conductive layer having a first area, the conductive layer including a main display region having an area smaller than the first area;
a backlight in alignment with the conductive layer having second area larger than the main display region area;
a non-main display region of the conductive layer proximal the main display region; and
the non-main display region of the conductive layer including at least one shutter configured to allow light from the backlight to pass therethrough and configured to block light from passing therethrough.

2. The display of claim 1, further comprising an icon which is configured to be visible when the shutter allows light from the backlight to pass therethrough.

3. The display of claim 2, further comprising a color filter of the icon.

4. The display of claim 1, further comprising a touch screen associated with the shutter configured to be responsive to touch when the shutter allows light from the backlight to pass therethrough.

5. The display of claim 1 further comprising:
a plurality of icons associated with the shutter.

6. The display of claim 1, wherein the shutter is configured to be activated by an active matrix.

7. The display of claim 1, wherein the shutter is configured to be activated remotely.

8. The display of claim 1 wherein the non-main display region of the conductive layer is a perimeter region of the conductive layer.

9. The display of claim 1, further comprising:
at least one polarizer in alignment with the backlight, the polarizer having an area substantially the same as the area main display region of the conductive layer.

10. The display of claim 1, further comprising:
a liquid crystal in alignment with the backlight.

11. A method of a display of an electronic device, comprising:
activating a backlight having a backlight area;
activating a shutter of a conductive layer, the conductive layer being in alignment with the backlight, the conductive layer including a main display region having an area smaller than the backlight area, the shutter disposed in a non-main display region of the conductive layer proximal the main display region, the shutter being configured to allow light from the backlight to pass therethrough and configured to block light from passing therethrough.

12. The method of claim 11 wherein activating the shutter allows light from the backlight to pass therethrough, illuminating an icon.

13. The method of claim 11 wherein activating the shutter blocks light from the backlight from passing therethrough, darkening an icon.

14. The method of claim 11 further comprising:
illuminating one of a plurality of icons that is viewable when the shutter allows light from the backlight to pass therethrough, each of the plurality of icons associated with a different color filter from the others.

15. The method of claim 14, further comprising:
illuminating one of a plurality of icons depending upon a mode or application of the device being active.

16. The method of claim 12 wherein the shutter is associated with a touch screen that is configured to receive touch signals when the shutter allows light from the backlight to pass therethrough, the method comprising:
receiving a touch signal from the touch screen when the shutter allows light from the backlight to pass therethrough.

17. The method of claim 11, further comprising:
activating the main display.

18. A display of an electronic device, comprising:
a backlight having a backlight area;
a conductive layer in alignment with the backlight, the conductive layer including a main display having an area smaller than the backlight area;
a non-main display region of the conductive layer proximal the main display; and
at least one shutter disposed in the non-main display region of the conductive layer and configured to allow light from the backlight to pass therethrough so that when light passes therethrough an icon is illuminated;
a touch screen associated with the at least one shutter configured to be responsive to touch when the at least one shutter allows light from the backlight to pass therethrough; and
a controller configured to receive a signal from the touch screen to activate a function of the device.

19. The device of claim 18 wherein the device is a mobile communication having at least one mode including a camera mode having functions still, video, zoom in, zoom out, flash, capture, trash, or back, or a media playback mode having functions rewind, play, fastforward, or a video conference mode, or an internet link mode,

20. The display of claim 18 wherein the non-main display region of the conductive layer is a perimeter region of the conductive layer.
